(19) United States
(12) Patent Application Publication
(10) Pub. No.: US 2007/0111873 A1
(43) Pub. Date: May 17, 2007

(54) Paper feed roller

(75) Inventors: Yasuchika Ito, Hyogo (JP); Hirokazu Nishimori, Hyogo (JP); Akihiro Mine, Hyogo (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/583,115

(22) Filed: Oct. 19, 2006

(30) Foreign Application Priority Data
Nov. 15, 2005 (JP) 2005-330074

(51) Int. Cl. F16C 13/00

(52) U.S. Cl. 492/56

(57) ABSTRACT

A paper feed roller having an inner layer and an outer layer both consisting of rubber, with a peripheral surface of the inner layer and an inner peripheral surface of the outer layer in close contact without forming a gap therebetween. A rubber component of the inner layer consists of butyl rubber. A rubber component of the outer layer consists of EPDM, silicone rubber or urethane rubber. The JIS-A hardness of the inner layer is set to not more than 10 degrees, and the JIS-A hardness of the outer layer is set to not less than 25 nor more than 60 degrees.

This nonprovisional application claims priority under 35 U.S.C. §119(a) on Patent Application No(s). 2005-330074 filed in Japan on Nov. 15, 2005, the entire contents of which are hereby incorporated by reference.

### FIELD OF THE INVENTION

The present invention relates to a paper feed roller for use in a paper feed mechanism of a copying machine, a printer, a facsimile apparatus, an automatic teller machine (ATM), and the like. More particularly, in the paper feed roller of the present invention, an annular elastic member (rubber roller) mounted on the peripheral surface of a shaft has a two-layer construction composed of an inner layer and an outer layer to reduce a drop of the coefficient of friction and generation of a chattering phenomenon.

### DESCRIPTION OF THE RELATED ART

Various types of paper feed rollers are used for a paper feed mechanism of an electrostatic copying machine, various types of printers, a facsimile apparatus, an automatic teller machine (ATM), and the like. The paper feed roller means a roller that transports paper owing to friction between the surface thereof and paper, with the paper feed roller rotating in contact with the paper. The paper feed roller includes a paper stop roller, and a feed roller, a transfer roller, a conveyance roller, and the like.

As the material for the rubber roller used as the paper feed roller, natural rubber, urethane rubber, ethylene-propylene-diene rubber (EPDM rubber), polynorbornane rubber, silicone rubber, chlorinated polyethylene rubber, and the like have been hitherto used.

Many rubber rollers used as the paper feed roller have a one-layer construction consisting of a non-foamed layer. The coefficient of friction of the rubber roller having the one-layer construction is liable to drop as the number of paper supplied thereto increases. As a result, the rubber roller deteriorates in its paper feed performance. Thereby defective paper feed occurs or a chattering phenomenon is generated owing to sliding of paper on the surface of the rubber roller. In recent years, there are proposed rubber rollers having a two-layer construction or a three-layer construction to improve the wear resistance thereof and suppress a reduction in the coefficient of friction thereof.

For example, disclosed in Japanese Patent Application Laid-Open No. 2001-341862 (patent document 1) is the rubber roller having the two-layer construction composed of the foamed inner layer and the non-foamed outer layer. Also disclosed in the patent document 1 is the rubber roller having the three-layer construction composed of the non-foamed inner layer, the foamed intermediate layer, and the non-foamed outer layer.

In the patent document 1, to allow the rubber roller to have a preferable coefficient of friction and a proper nip amount, the ASKER-C hardness of the foamed layer is adjusted to not more than 50 degrees, and the JIS-A hardness of the non-foamed layer is adjusted to not more than 60 degrees. The inner layer of the rubber roller having the three-layer construction is provided to fix the rubber roller to the shaft firmly.

Disclosed in Japanese Patent Application Laid-Open No. 2002-48130 (patent document 2) is the rubber roller having the three-layer construction composed of the non-foamed base rubber layer (inner layer) and the comparatively thin non-foamed intermediate and outer layers formed on the peripheral surface of the base rubber layer. Proposed in the patent document 2 is the composition of the base rubber layer effective for improving the fatigue resistance of the rubber roller and suppressing the generation of bleeding, but the hardness of the intermediate layer and that of the outer layer are not specified. Thus the rubber roller used as the paper feed roller is incapable of restraining the coefficient of friction thereof from decreasing as the number of paper supplied thereto increases and restraining chattering from being generated when the rubber roller feeds paper.

The rubber roller having the two-layer construction composed of the inner layer and the outer layer is disclosed in Japanese Patent Application Laid-Open No. 2002-347972 (patent document 3). The JIS-A hardness of the inner layer and that of the outer layer are adjusted to a specific range respectively. To improve the wear resistance of the outer layer and reduce the generation of the chattering phenomenon, the JIS-A hardness of the outer layer is adjusted to the range of 35 to 50 degrees, and that of the inner layer is adjusted to not more than 25 degrees respectively.

An effect is obtained in improving the wear resistance of the outer layer and reducing the generation of the chattering phenomenon by the construction of the rubber rollers, disclosed in the patent documents 1 and 3, in which the rubber of the outer layer has a high hardness and the rubber of the inner layer has a low hardness. But the paper feed rollers are constructed without considering the prevention of the migration of substances contained in the rubber composition between the inner layer and the outer layer and the occurrence of bleeding. Thus there is room for improvement in the paper feed rollers disclosed in the patent documents 1 and 3.

Patent document 1: Japanese Patent Application Laid-Open No. 2001-341862

Patent document 2: Japanese Patent Application Laid-Open No. 2002-48130

Patent document 3: Japanese Patent Application Laid-Open No. 2002-347972

### SUMMARY OF THE INVENTION

The present invention has been made in view of the above-described problems. Therefore it is an object of the present invention to provide a paper feed roller capable of maintaining a superior performance for a long time by so constructing the paper feed roller that it has a high coefficient of friction and wear resistance and a low extent of decrease in the coefficient of friction thereof after the paper feed roller feeds a large number of paper, that the generation of a chattering phenomenon is reduced to a high extent when the paper feed roller feeds paper, and that substances contained in a rubber composition composing the paper feed roller are restrained from migrating between an inner layer and an outer layer thereof.

To solve the above-described problems, the present invention provides a paper feed roller having an inner layer and an outer layer both consisting of rubber, with a peripheral surface of the inner layer and an inner peripheral surface of the outer layer in close contact without forming a gap therebetween. A rubber component of the inner layer consists of butyl rubber. A rubber component of the outer layer consists of EPDM, silicone rubber or urethane rubber. A JIS-A hardness of the inner layer is set to not more than 10 degrees. The JIS-A hardness of the outer layer is set to not less than 25 nor more than 60 degrees.

As described above, the paper feed roller (hereinafter often abbreviated as “rubber roller” or “roller”) is composed of the inner layer and the outer layer both consisting of rubber, with the peripheral surface of the inner layer and the inner peripheral surface of the outer layer in close contact without forming a gap therebetween. Thereby the entire roller is allowed to have a predetermined uniform hardness, with the outer layer layered on the inner layer. Therefore it is possible to prevent the roller from being locally worn and restrain the outer diameter thereof from becoming nonuniform.

As described above, by setting the JIS-A hardness of the inner layer to a low degree not more than 10 degrees, it is possible to secure the area of contact between the paper feed roller and paper, restrain a drop of the coefficient of friction thereof, and reduce the generation of the chattering phenomenon. When the JIS-A hardness of the inner layer is more than 10 degrees, it is difficult to secure the area of contact between the roller and the paper for a long time and suppress the drop of the coefficient of friction of the roller. The lower limit of the JIS-A hardness of the inner layer is not less than “0”. The hardness “0” means that because the roller has an extremely low hardness, the needle of a durometer does not swing and thus points “0”.

By setting the JIS-A hardness of the outer layer high not less than 25 nor more than 60 degrees, the roller is capable of having a favorable balance between the wear resistance and the coefficient of friction thereof. When the JIS-A hardness of the outer layer is less than 25, the roller has a low wear resistance. On the other hand, when the JIS-A hardness of the outer layer is more than 60, the roller has a low coefficient of friction. Thereby the roller does not have a sufficient performance.

To sufficiently suppress the drop of the coefficient of friction of the paper feed roller and the generation of the chattering phenomenon, it is desirable that the difference between the JIS-A hardness of the outer layer 13 and the JIS-A hardness of the inner layer 11 is set to the range of 15 to 55 degrees. If the difference between the JIS-A hardness of the outer layer 13 and that of the inner layer 11 is less than 15 degrees, it is impossible to obtain the effect of suppressing the generation of the chattering phenomenon. On the other hand, if the difference between the JIS-A hardness of the outer layer 13 and that of the inner layer 11 is more than 55 degrees, the outer layer has a high rubber hardness and hence a low coefficient of friction. It is more favorable that the difference between the JIS-A hardness of the outer layer 13 and that of the inner layer 11 is in the range of 20 to 50 degrees.

The initial coefficient of friction of the peripheral surface of the outer layer is set to favorably not less than 1.5 and more favorably not less than 2.0 nor more than 3.5.

As described above, the rubber component of the inner layer consists of the butyl rubber. It is possible to set the JIS-A hardness of the inner layer to not more than 10 degrees, when the ethylene-propylene-diene rubber (EPDM) is used as the rubber component of the inner layer. But to reduce the JIS-A hardness to not more than 10 degrees, it is necessary to add a large amount of a softening agent (paraffin oil) to the EPDM rubber. Thus the oil migrates to the outer layer and bleeds. To prevent the oil from migrating to the outer layer, it is necessary to form a barrier layer between the inner layer and the outer layer. In the present invention, because the rubber component of the inner layer consists of the butyl rubber, it is possible to set the JIS-A hardness of the inner layer to not more than 10 degrees without adding a large amount of the softening agent thereto. Thus it is possible to restrain the oil from migrating to the outer layer and bleeding. Thereby it is unnecessary to form the barrier layer between the inner layer and the outer layer to prevent the migration of the oil to the outer layer. Because the butyl rubber has a low impact resilience and a high vibration-absorbing performance, the butyl rubber is effective for decreasing the generation of the chattering phenomenon.

As described above, because the rubber component of the outer layer consists of the EPDM rubber, the silicone rubber or the urethane rubber, the roller is excellent in its ozone resistance. Because most of main chains of the EPDM rubber consists of saturated hydrocarbons, the EPDM rubber does not contain a large number of double bonds in the main chain. Thus even though the EPDM is exposed to a high-concentration ozone atmosphere or irradiated with light beams for a long time, the molecular main chain thereof is hardly cut. In addition, the silicone rubber and the urethane rubber are also ozone-resistant. Because the urethane rubber is excellent in its mechanical properties, the urethane rubber is effective for improving the wear resistance of the rubber composition of the roller.

The rubber layers composing the paper feed roller of the present invention are obtained by crosslinking the above-described rubber composition. The crosslinking form is not limited to a specific one. It is possible to use sulfur crosslinking, metal salt crosslinking, peroxide crosslinking, resin crosslinking, and electron beam crosslinking. The sulfur crosslinking is generally used. A vulcanization accelerator may be used in combination with sulfur in the crosslinking. Blooming may occur on the surface of the roller in the sulfur crosslinking in dependence on a use condition. In this case, the resin crosslinking may be used.

The rubber composition may appropriately contain a softening agent, a filler, a reinforcing agent, and the like. It is preferable to use a necessary amount of the softening agent or the filler to adjust the hardness of the inner layer and that of the outer layer.

In obtaining a roller-shaped molded product of a crosslinked rubber composition, the above-described components are kneaded. Kneaded components are crosslinked before or after they are molded. Further, to reduce a work time, the kneaded components may be crosslinked simultaneously with the molding thereof. In forming the roller-shaped rubber layer by crosslinking the kneaded components simultaneously with the molding thereof, after a tube-shaped die having a desired configuration is heated, the above-described kneaded components are filled in the heated die. Thereafter compression molding (press vulcanization) is performed.

In the paper feed roller of the present invention, the outer rubber layer is layered on the inner rubber layer as follow: After both rubber layers are formed separately, the inner rubber layer is inserted into a hollow portion of the outer rubber layer by press fit or the outer rubber layer is fitted on the inner rubber layer, with the outer rubber layer in close contact with the inner rubber layer. In this case, it is preferable that the outer rubber layer is integrally fitted on the peripheral surface of the inner rubber layer without interposing an adhesive agent between the outer rubber layer and the rubber inner layer. By integrally fitting the outer rubber layer on the peripheral surface of the inner rubber layer without interposing the adhesive agent therebetween, the outer rubber layer can be exchanged, when the outer rubber layer deteriorates and completes its life owing to the contact between the outer rubber layer and outside air as well as paper.

As described above, according to the present invention, the paper feed roller is composed of the inner layer and the outer layer both consisting of rubber, with the peripheral surface of the inner layer and the inner peripheral surface of the outer layer in close contact without forming a gap therebetween. Thereby the entire paper feed roller is allowed to have a predetermined uniform hardness, with the outer layer layered on the inner layer. Thus the paper feed roller is capable of maintaining a wear resistance. Further the rubber component of the inner layer consists of the butyl rubber. Thus it is possible to restrain oil from migrating to the outer layer and bleeding without forming the barrier layer between the inner layer and the outer layer. Because the butyl rubber absorbs vibration to a high extent, the butyl rubber is effective for decreasing the generation of the chattering phenomenon.

By setting the JIS-A hardness of the inner layer to a low degree not more than 10 degrees, it is possible to secure the area of contact between the paper feed roller and paper. Hence it is possible to suppress a drop of the coefficient of friction of the roller and reduce the generation of the chattering phenomenon. By setting the JIS-A hardness of the outer layer to a high degree not less than 25 nor more than 60 degrees, the roller is capable of having a favorable balance between the wear resistance and the coefficient of friction thereof.

The rubber component of the outer layer consists of the EPDM rubber, the silicone rubber or the urethane rubber. Therefore the paper feed roller is excellent in its wear resistance and ozone resistance.

Therefore according to the present invention, the paper feed roller has the following effects: It has a high wear resistance, a high coefficient of friction, and a low degree of a drop in the coefficient of friction thereof after the paper feed roller feeds a large number of paper. Further the paper feed roller generates the chattering phenomenon to a low extent when it feeds paper. Furthermore it is possible to restrain substances contained in the rubber composition of the paper feed roller from migrating between the inner layer and the outer layer thereof. Therefore the paper feed roller has a very long life and is capable of maintaining an excellent performance for a long time.

### BRIEF DESCRIPTION OF THE DRAWINGS

FIG. 1 is a schematic perspective view showing a paper feed roller of an embodiment of the present invention.

FIG. 2 is a sectional view showing an example of a paper feed mechanism including the paper feed roller of the embodiment shown in FIG. 1.

FIG. 3 is a sectional view showing the paper feed roller of the embodiment shown in FIG. 1.

FIG. 4 illustratively shows the method of measuring the coefficient of friction of the paper feed roller shown in FIG. 1.

### DETAILED DESCRIPTION OF THE PREFERRED EMBODIMENTS

The embodiments of the present invention will be described below with reference to drawings.

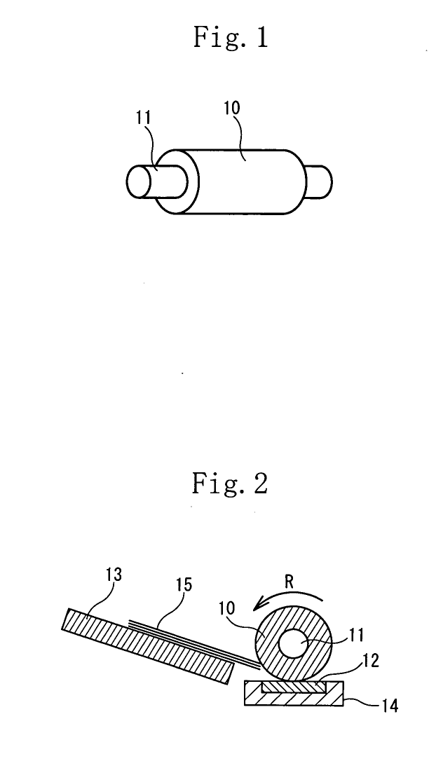

FIG. 1 is a schematic perspective view showing a paper feed roller 10 of the present invention and a shaft 11 thereof. By inserting the shaft 11 into a hollow portion of the paper feed roller 10 by press fit, the paper feed roller 10 is fixed to the shaft 11.

Although the thickness of the paper feed roller 10 is not set specifically, the thickness thereof is set to not less than 1 mm nor more than 20 mm. Although the length of the paper feed roller 10 is not set specifically, the length thereof is set to not less than 3 mm nor more than 200 mm.

FIG. 2 is an illustrative sectional view showing an example of a paper feed mechanism in which the paper feed roller 10 is used as a paper supply roller. The paper feed mechanism has a paper feed roller 10, a separation pad 12, and a tray 13. The separation pad 12 and the tray 13 are spaced at a certain interval. An angle of elevation is formed between an upper surface of the separation pad 12 and the tray 13. The separation pad 12 is fixed to a substrate 14. The separation pad 12 and the paper feed roller 10 are opposed to each other.

Owing to a rotation of the paper feed roller 10, paper 15 disposed on the tray 13 is fed out of the tray 13 one by one in the direction shown by the arrow R of FIG. 1, with the paper 15 in contact with the surface of the paper feed roller 10.

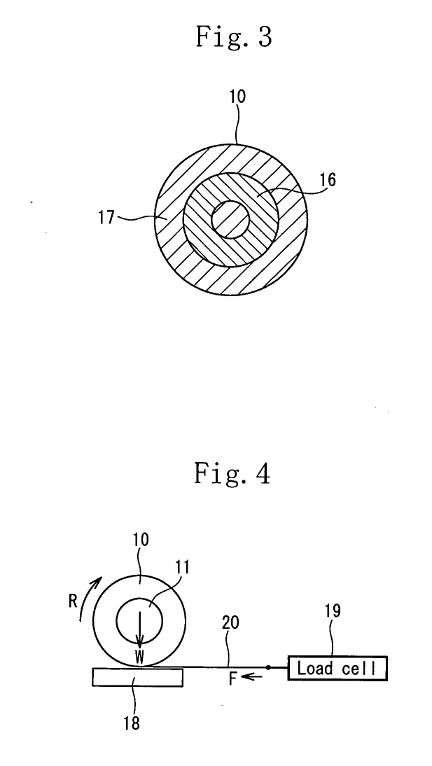

As shown in FIG. 3 which is a sectional view, the paper feed roller 10 is composed of two rubber layers, namely, an inner rubber layer 16 and an outer rubber layer 17. A peripheral surface of the inner rubber layer 16 and an inner peripheral surface of the outer rubber layer 17 are in close contact without forming a gap therebetween.

A rubber composition of the inner rubber layer 16 is vulcanized to shape it cylindrically and has a hardness not more than 10 degrees (five degrees in the first embodiment) in the JIS-A hardness. Although the thickness of the inner rubber layer 16 is not specifically limited, it is set to not less than 2 mm nor more than 10 mm. If the thickness of the inner rubber layer 16 is too small, it has a small effect of suppressing the generation of the chattering phenomenon. On the other hand, if the thickness of the inner rubber layer 16 is too large, the inner rubber layer 16 is liable to be locally worn.

A rubber composition composing the inner rubber layer 16 contains butyl rubber and various additives including a crosslinking agent, a filler, a softening agent, a reinforcing agent, a crosslinking assistant, a coloring agent, and an antioxidant.

A rubber composition of the outer rubber layer 17 is vulcanized to shape it cylindrically and has a hardness not less than 25 nor more than 60 degrees (25 in the first embodiment) in the JIS-A hardness. To sufficiently restrain the drop of the coefficient of friction of the paper feed roller and the generation of the chattering phenomenon, the difference between the JIS-A hardness of the outer layer 17 and the JIS-A hardness of the inner layer 16 is set to the range of 15 to 55 degrees (20 degrees in the first embodiment).

The thickness of the outer rubber layer 17 is not set specifically, but is set preferably not less than 1 mm nor more than 3 mm. If the thickness of the outer rubber layer 17 is too small, there is a fear that the roller has a short life. On the other hand, if the thickness of the outer rubber layer 17 is too large, there is a fear that the effect of softening the inner rubber layer 16 is lost.

The rubber composition constituting the outer rubber layer 17 contains the EPDM rubber essentially and the above-described various additives. It is possible to use both oil-unextended EPDM rubber consisting of a rubber component and oil-extended EPDM rubber containing the EPDM rubber component and extended oil.

As crosslinking agents which can be contained in the rubber composition, it is possible to use sulfur, sulfur compounds, metal oxides, organic peroxides, and inorganic peroxides. It is preferable to select an appropriate crosslinking agent in dependence on the kind of rubber.

As the sulfur compounds, it is possible to use thiuram compounds such as tetramethylthiuram monosulfide (TMTM), tetramethylthiuram disulfide (TMTD), tetraethylthiuram disulfide (TETD), tetrabutylthiuram disulfide (TBTD), dipentamethylenethiuram tetrasulfide (DPTT); thiazole compounds such as 2-mercapto•benzothiazole (MBT), dibenzothiazyl disulfide; zinc salt of 2-mercapto•benzothiazole (ZnMBT), sodium salt of 2-mercapto•benzothiazole (NaMBT), cyclohexylamine salt of 2-mercapto•benzothiazole (CMBT), 2-(2,4-dinitrophenylthio)benzothiazole (DPBT); sulfenamide compounds such as N-cyclohexyl-2-benzothiazolylsulfenamide (CBS), N-t-butyl-2-benzothiazolylsulfenamide (BBS), N-oxydiethylene-2-benzothiazolylsulfenamide (OBS), N,N′-diisopropyl-2-benzothiazolylsulfenamide (DPBS), N,N′-dicyclohexyl-2-benzothiazolylsulfenamide; and compounds of metal dithiocarbamate such as dimethyldithiocarbamate, diethyldithiocarbamate, di-n-butyldithiocarbamate, pentamethylenedithiocarbamate, and ethylphenyldithiocarbamate. These sulfur compounds can be used singly or in combination of two or more of them.

As the metal oxides, it is possible to use zinc oxide, magnesium oxide, and aluminum oxide. These metal oxides can be used singly or in combination of two or more of them.

As the organic peroxides, the following substances are preferable: dicumyl peroxide (DCP), 1,3-bis(t-butyl peroxyisopropyl)benzene, 1,4-bis(t-butyl peroxyisopropyl)3,3,5-trimethylcyclohexane, 2,5-dimethyl-2,5-di-(t-butyl peroxy)hexyne, n-butyl-4,4-bis(t-butyl peroxy)valerate, and 2,5-dimethyl-2,5-bis(t-butyl peroxy)hexane. These peroxides can be used singly or in combination of two or more of them.

As the inorganic peroxides, it is possible to use hydrogen peroxide, and the like. The inorganic peroxides can be used singly or in combination of two or more of them.

As the filler which can be contained in the rubber composition, it is possible to use mineral inorganic fillers such as calcium carbonate, titanium oxide, magnesium carbonate, and the like; ceramic powder; and wood powder. The rubber composition containing the fillers improves the mechanical strength of the rubber roller. It is preferable that the mineral inorganic filler is contained in the rubber composition constituting the outer rubber layer 17.

As the softening agent which can be contained in the rubber composition, oil, a plasticizer, and the like can be used. It is possible to adjust the hardness of the rubber composition by adding the softening agent to the rubber component. As the oil, it is possible to use mineral oil such as paraffin oil, naphthenic oil, aromatic oil; synthetic oil consisting of hydrocarbon oligomer; and process oil. As the synthetic oil, oligomer of α-olefin, oligomer of butene, and amorphous oligomer of ethylene and α-olefin are preferable. As the plasticizer, it is possible to use dioctyl phthalate (DOP), dibutyl phthalate (DBP), dioctyl sebacate (DOS), and dioctyl adipate (DOA).

Carbon black or the like can be used as the reinforcing agent that can be contained in the rubber composition. It is possible to improve the wear resistance of the rubber roller by adding the carbon black to the rubber component. As the carbon black, it is possible to use HAF, MAF, FEF, GPF, SRF, SAF, MT, and FT. It is preferable that the diameter of the particle of the carbon black is not less than 10 nm nor more than 100 nm to disperse the carbon black favorably in the rubber composition. In the present invention, to increase the strength of the rubber, it is preferable for the rubber composition constituting the inner layer to contain the carbon black.

It is preferable that the rubber composition constituting the inner rubber layer 16 contains 1 to 15 parts by weight of the carbon black and 20 to 100 parts by weight of the paraffin oil per 100 parts by weight of the butyl rubber.

It is preferable that the rubber composition constituting the outer rubber layer 17 contains 1 to 50 parts by weight of the mineral inorganic filler and not more than 140 parts by weight of the paraffin oil per 100 parts by weight of the EPDM rubber. As the mineral fillers, it is preferable to use silicon oxide, calcium carbonate, titanium oxide, and the like singly or in combination.

The rubber composition is formed by using ordinary methods conventionally carried out. For example, rubber, a crosslinking agent, and additives are kneaded by using a known rubber kneading apparatus such as an open roll, a Banbury mixer, a kneader, and the like to obtain the rubber composition. The components are kneaded at 70° C. to 100° C. for about three to 10 minutes.

As the method of vulcanizing and molding the rubber composition, it is possible to use extrusion molding, transfer molding or the like. For example, it is possible to vulcanize the rubber composition and mold it tubularly at the same time by introducing an unvulcanized rubber composition into a transfer molding die and heating it at 150° C. to 200° C. for five to 30 minutes. Thereafter an obtained rubber tube is abraded with a cylindrical grinder until the rubber tube has a desired outer diameter. Then the rubber tube is cut to a desired length. Thereby the inner rubber layer 16 and the outer rubber layer 17 can be obtained.

Without using an adhesive agent, the tubular outer layer 17 can be fitted on the peripheral surface of the inner rubber layer 16. In this case, it is desirable to set the inner diameter φa of the outer rubber layer 17 a little smaller than the outer diameter φb of the inner rubber layer 16. More specifically, it is desirable to set the ratio of the inner diameter φa to the outer diameter φb to the range from 0.80 to 0.95.

Because the paper feed roller 10 of the first embodiment has the above-described construction, it has the following advantages: it has a high wear resistance and a high coefficient of friction. Further, after the paper feed roller 10 feeds a large number of paper, it has a low degree of a drop in the coefficient of friction thereof. Furthermore the paper feed roller 10 generates the chattering phenomenon to a low extent when the paper feed roller 10 feeds paper. In addition, it is possible to restrain substances contained in the rubber composition of the paper feed roller 10 from migrating between the inner layer 16 and the outer layer 17 thereof. Therefore the paper feed roller 10 has a very long life and is capable of maintaining an excellent performance for a long time.

A paper feed roller 10 of the second embodiment of the present invention is formed in a manner similar to that of the first embodiment except that a rubber composition composing an outer rubber layer 17 consists of silicone rubber.

The paper feed roller 10 of the second embodiment has also a high wear resistance and a high coefficient of friction. Further, after the paper feed roller 10 feeds a large number of paper, it has a low degree of a drop in the coefficient of friction thereof after the paper feed roller 10 feeds a large number of paper. Furthermore, the paper feed roller 10 generates the chattering phenomenon to a low extent when the paper feed roller 10 feeds paper. In addition, it is possible to restrain components of the paper feed roller 10 from migrating between the inner layer 16 and the outer layer 17 thereof. Therefore the paper feed roller 10 is capable of maintaining an excellent performance for a long time.

A paper feed roller 10 of the third embodiment of the present invention is formed in a manner similar to that of the first embodiment except that a rubber composition composing an outer rubber layer 17 consists of urethane rubber.

As a preferable example of the mixing ratio of components composing the outer layer 17, it is possible to use 1 to 30 parts by weight of mineral inorganic filler and not more than 50 parts by weight of di-(butoxy-ethoxy-ethyl)adipate per 100 parts by weight of the urethane rubber.

The paper feed roller 10 of the third embodiment has also a high wear resistance and a high coefficient of friction. Further after the paper feed roller 10 feeds a large number of paper, it has a low degree of a drop in the coefficient of friction thereof. Furthermore, the paper feed roller 10 generates the chattering phenomenon to a low extent when the paper feed roller 10 feeds paper. In addition, it is possible to restrain components of the paper feed roller 10 from migrating between the inner layer 16 and the outer layer 17 thereof. Therefore the paper feed roller 10 is capable of maintaining an excellent performance for a long time.

The paper feed rollers of examples 1 through 5 of the present invention and paper feed rollers of the comparison examples 1 through 3 will be described in detail below.

The rubber composition of each of the examples and the comparison examples was prepared in accordance with formulations A through G shown in table 1. The unit of the numerical values showing amounts of the components is part by weight.

TABLE 1

| | Inner layer | | | Outer layer | | | | | |
|---|---|---|---|---|---|---|---|---|---|
| Formulation | A | B | C | D | E | F | G | H | I |
| Butyl rubber | 100 | 100 | 100 | | | | | | |
| EPDM rubber A | | | | 200 | 200 | 200 | | | |
| EPDM rubber B | | | | | | | 100 | | |
| Silicon oxide | | | | 10 | 10 | 15 | 10 | 10 | |
| Calcium carbonate | | | | 30 | 30 | 30 | | | |
| Titanium oxide | | | | 15 | 15 | 15 | 5 | | |
| Carbon black | 5 | 5 | 5 | 1 | 1 | 1 | 1 | 1 | |
| Paraffin oil | 65 | 55 | 45 | 40 | 20 | | | | |
| Zinc oxide | 5 | 5 | 5 | 5 | 5 | 5 | 5 | 5 | |
| Stearic acid | 1 | 1 | 1 | 1 | 1 | 1 | 1 | 1 | |
| Powdery sulfur | 1 | 1 | 1 | 1 | 1 | 1 | 1 | 1 | |
| Tetraethylthiuram disulfide | | | | 2 | 2 | 2 | 2 | 2 | |
| Tetrabutylthiuram disulfide | 2 | 2 | 2 | | | | | | |
| Dibenzothiazyl disulfide | 1 | 1 | 1 | 1 | 1 | 1 | 1 | 1 | |
| Urethane rubber | | | | | | | | 100 | |
| Di-(butoxy•ethoxy•ethyl) adipate | | | | | | | | 25 | |
| Silicone rubber | | | | | | | | | 100 |
| Hardness (degree) | 5 | 10 | 15 | 20 | 25 | 30 | 60 | 33 | 30 |

The components shown in table 1 are as follows:

Butyl rubber: “Butyl 268 (commercial name)” produced by JSR Corporation.

EPDM rubber A: “Esprene 670F (commercial name)” produced by Sumitomo Chemical Co.,Ltd.

EPDM rubber B: “Esprene 505A (commercial name)” produced by Sumitomo Chemical Co.,Ltd.

Silicon oxide: “Nipseal VN3 (commercial name)” produced by Nippon Silica.

Calcium carbonate: “BF300 (commercial name)” produced by Bihoku Funka Kogyo Co., Ltd.

Titanium oxide: “Chronos titanium oxide KR380 (commercial name)” produced by Titanium Kogyo Inc.

Paraffin oil: “PW-380” (commercial name)” produced by Idemitsu Kosan Co., Ltd.

Zinc oxide: “two kinds of zinc oxide” (commercial name) produced by Mitsui Mining and Smelting Co., Ltd.

Stearic acid: “Tsubaki (commercial name)” produced by NOF Corporation.

Powdery sulfur: Powdery sulfur produced by Tsurumi Chemical Industry Co., Ltd.

Tetraethylthiuram disulfide: “Nocceler TBT (commercial name)” produced by Ouchishinko Chemical Industrial Co., Ltd.

Dibenzothiazyl disulfide: “Nocceler DM (commercial name)” produced by Ouchishinko Chemical Industrial Co., Ltd.

Urethane rubber: “Millathane 76 (commercial name)” produced by TSE Industries.

Di-(butoxy-ethoxy-ethyl) adipate: “TP-95 (commercial name)” produced by Rhom and Haas Japan K.K.

Silicone rubber: “XE-20-B3250 (commercial name) produced by GE Toshiba Silicone Co. Ltd.

The EPDM rubber A is oil-extended rubber containing 50 wt % of the EPDM rubber and 50 wt % of extended oil.

### COMPARISON EXAMPLE 1

A solid (one layer) rubber roller was prepared in a manner described below. Initially a rubber composition having the formulation E shown in table 2 was introduced into a predetermined die to perform press vulcanization at 170° C. for 20 minutes. Thereby a cot having an inner diameter of ø9 mm, an outer diameter of ø21 mm, and a length of 38 mm was obtained. Thereafter the obtained cot was abraded with a cylindrical grinder until the outer diameter thereof became ø20 mm. Thereafter the cot was cut to obtain a rubber roller having a length of 10 mm. A shaft was inserted into the rubber roller obtained by cutting the cot. Thereby the paper feed roller of the comparison example 1 was obtained.

### EXAMPLES 1 THROUGH 5 AND COMPARISON EXAMPLES 2 AND 3

(i) Formation of Inner Layer

A rubber composition having a predetermined formulation shown in table 2 was introduced into a predetermined die to perform press vulcanization at 160° C. for 30 minutes. Thereby a cot having an inner diameter of ø9 mm, an outer diameter of ø15 mm, and a length of 60 mm was obtained. Thereafter the cot was cut to obtain an inner rubber layer having a length of 10 mm.

(ii) Formation of Outer Layer

A rubber composition having a predetermined composition shown in table 2 was introduced into a predetermined die to perform press vulcanization at 160° C. for 20 minutes. Thereby a cot having an inner diameter of ø14 mm, an outer diameter of ø21 mm, and a length of 60 mm was obtained. Thereafter the obtained cot was abraded with a cylindrical grinder until the outer diameter thereof became ø20 mm. Then the cot was cut to obtain an outer rubber layer having a length of 10 mm.

(iii) Formation of Paper Feed Roller Having Two-Layer Construction

A shaft was inserted into a hollow portion of the inner rubber layer. Thereafter the outer rubber layer was fitted on the peripheral surface of the inner rubber layer without using an adhesive agent. In this manner, the paper feed roller was completed.

TABLE 2

| | CE1 | E1 | E2 | E3 | E4 | E5 | CE2 | CE3 |
|---|---|---|---|---|---|---|---|---|
| Formulation of inner layer | | A | B | A | A | A | C | B |
| Hardness (degree) of inner layer | | 5 | 10 | 5 | 5 | 5 | 15 | 10 |
| Formulation of outer layer | | E | F | G | H | I | E | D |
| Hardness (degree) of outer layer | | 25 | 30 | 60 | 33 | 30 | 25 | 20 |
| Difference between JIS-A hardness of | | 20 | 20 | 55 | 28 | 25 | 10 | 10 |
| inner layer and that of outer layer | | | | | | | | |
| One-layer construction | E | | | | | | | |
| Hardness (degree) of one-layer | 25 | | | | | | | |
| construction | | | | | | | | |
| Initial coefficient of friction | 1.9 | 2.1 | 2.0 | 1.7 | 1.8 | 1.9 | 2.0 | 2.1 |
| Coefficient of friction after | 1.5 | 2.0 | 1.9 | 1.6 | 1.7 | 1.7 | 1.5 | — |
| feed of paper | | | | | | | | |
| Evaluation of chattering | Chattered | Did not | Did not | Did not | Did not | Did not | Chattered | Did not |
| | | chatter | chatter | chatter | chatter | chatter | | chatter |
| Evaluation of paper feed (50,000 | ◯ | ◯ | ◯ | ◯ | ◯ | ◯ | ◯ | X |
| sheets) | | | | | | | | |

E and CE in the uppermost column indicate example and comparison example respectively.

Evaluation
Hardness of Inner Layer and Outer Layer

In accordance with the description specified in “Hardness testing methods for rubber, vulcanized or thermoplastic” of JIS-K6253, the JIS-A hardness of each paper feed roller was measured by using a testing machine of a type-A durometer. The hardness is equivalent to the conventional Shore hardness A which is an international standard indication. Table 1 shows the JIS-A hardness of the inner layer and the outer layer and also the difference between the JIS-A hardness of the inner layer and that of the outer layer.

Initial Coefficient of Friction

The coefficient of friction of each paper feed roller was measured by using a method illustrated in FIG. 4. Initially one end of a sheet of paper 20 (produced by Fuji Xerox Co., Ltd.) having a size of 60 mm×210 mm was sandwiched between a paper feed roller 10 and a fixed plate 18 made of polytetrafluoroethylene (PTFE), with the other end of the paper 20 connected to a load cell 10. Thereafter a load W of 250 gf was vertically applied to the plate 18 in the direction from the paper feed roller 10 toward the plate 18.

Thereafter the paper feed roller 10 was rotated at a peripheral speed of 300 mm/second in the direction shown with the arrow R in FIG. 4 at a temperature of 23° C. and a humidity of 55%. A transport force F applied to the load cell 19 at that time was measured. The coefficient of friction μ was computed from the transport force F and the load W (W=250 gf) by using an equation 1 shown below:
μ=F(gf)/250(gf) <Equation 1>

In order for the paper feed roller to perform a desired function, it is necessary that the initial coefficient of friction thereof is not less than 1.5.

Evaluation of Feed of Paper

Each paper feed roller was mounted on a copying apparatus “VIVACE455 (commercial name)” manufactured by Fuji Xerox Co., Ltd. 50000 sheets of paper were fed to each paper feed roller to observe whether the paper was fed favorably. The paper feed roller which fed the paper favorably was marked by O. The paper feed roller which failed to feed the paper and the paper feed roller which fed a plurality of sheets of paper at a time were marked by X.

Friction of Coefficient after Feed of Paper

After the feed of the paper by each paper feed roller was evaluated, the paper feed roller was removed from the copying apparatus. In a method similar to that used in measuring the initial coefficient of friction, the coefficient of friction of each paper feed roller was measured after it fed 50000 sheets of paper.

In order for the paper feed roller to have a sufficient durability, it is necessary that the paper feed roller has not less than 1.2 as the coefficient of friction after it fed 50000 sheets of the paper.

Evaluation of Chatter

Each paper feed roller was mounted on the copying apparatus “VIVACE455 (commercial name)” manufactured by Fuji Xerox Co., Ltd. 1000 sheets of paper were fed to each paper feed roller to check whether the paper feed roller chattered. The paper feed roller which chattered during the feed of 1000 sheets of paper was marked by “chattered”. The paper feed roller which did not chatter during the feed of 1000 sheets of paper was marked by “did not chatter”.

Table 2 shows the results of the evaluation.

Examination of Results

The paper feed roller of the comparison example 1 having the one-layer construction was favorable in the evaluation of the feed of paper. But the paper feed roller chattered. The ratio of the coefficient of friction of the paper feed roller after it fed the paper to the initial coefficient of friction thereof was about 0.79. That is, the paper feed roller had a comparatively large reduction in its coefficient of friction.

Although the paper feed roller of the comparison example 2 having the two-layer construction was favorable in the evaluation of the feed of paper, it chattered because the inner layer thereof had a very high JIS-A hardness of 15 degrees. The ratio of the coefficient of friction of the paper feed roller after it fed the paper to the initial coefficient of friction thereof was about 0.75. That is, the paper feed roller had a comparatively large reduction in its coefficient of friction.

The paper feed roller of the comparison example 3 having the two-layer construction did not chatter. But the outer layer thereof had a very low JIS-A hardness of 20 degrees. Thus the outer layer was worn to a high extent in the evaluation of the feed of paper. That is, the paper feed roller cannot be practically used. The coefficient of friction of the paper feed roller could not be measured after it fed 50000 sheets of the paper.

Each of the paper feed rollers of the examples 1 through 4 had not more than 10 degrees in the JIS-A hardness of the inner layer thereof and not less than 25 degrees in the JIS-A hardness of the outer layer thereof. Thus the paper feed rollers did not chatter and were favorable in the evaluation of the feed of paper. The ratio of the coefficient of friction of each paper feed roller after it fed the paper to the initial coefficient of friction thereof was not less than 0.90. That is, the paper feed rollers had little drop in the coefficient of friction thereof.

### INDUSTRIAL APPLICABILITY

The paper feed roller of the present invention can be reliably used for a paper feed mechanism of various types of printers, an electrostatic copying machine, a facsimile apparatus, an automatic teller machine (ATM), and the like. The paper feed roller is very useful for a high-performance paper feed mechanism demanded to suppress the generation of the chattering phenomenon and have a high durability.

What is claimed is:

1. A paper feed roller comprising an inner layer and an outer layer both consisting of rubber, with a peripheral surface of said inner layer and an inner peripheral surface of said outer layer in close contact without forming a gap therebetween,
wherein a rubber component of said inner layer consists of butyl rubber; and a rubber component of said outer layer consists of EPDM, silicone rubber or urethane rubber; and
a JIS-A hardness of said inner layer is set to not more than 10 degrees, and said JIS-A hardness of said outer layer is set to not less than 25 nor more than 60 degrees.

2. The paper feed roller according to claim 1, wherein said outer layer is integrally fitted on said peripheral surface of said inner layer without interposing an adhesive agent between said outer layer and said inner layer.

3. The paper feed roller according to claim 1, wherein a difference between a JIS-A hardness of said outer layer and a JIS-A hardness of said inner layer is set to a range of 15 to 55 degrees.

4. The paper feed roller according to claim 2, wherein a difference between a JIS-A hardness of said outer layer and a JIS-A hardness of said inner layer is set to a range of 15 to 55 degrees.

5. The paper feed roller according to claim 1, wherein an initial coefficient of friction of said peripheral surface of said outer layer is set to not less than 1.5.

6. The paper feed roller according to claim 2, wherein an initial coefficient of friction of said peripheral surface of said outer layer is set to not less than 1.5.

7. The paper feed roller according to claim 3, wherein an initial coefficient of friction of said peripheral surface of said outer layer is set to not less than 1.5.

8. The paper feed roller according to claim 4, wherein an initial coefficient of friction of said peripheral surface of said outer layer is set to not less than 1.5.
